(19) United States
(12) Patent Application Publication
(10) Pub. No.: US 2002/0134757 A1
(43) Pub. Date: Sep. 26, 2002

(54) Vacuum circuit breaker

(76) Inventors: Shigeki Nishizumi, Tokyo (JP); Takeo Toyoda, Kanagawa-ken (JP); Toru Kamikawaji, Kanagawa-ken (JP); Isao Hioki, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/102,847

(22) Filed: Mar. 22, 2002

(30) Foreign Application Priority Data
Mar. 22, 2001 (JP) 2001-083657

(51) Int. Cl. H01H 33/66

(52) U.S. Cl. 218/118

(57) ABSTRACT

A vacuum circuit breaker including a metal tank containing insulation gas with a branched portion connecting a first bushing containing a vacuum valve, and another branched portion connecting a second bushing containing a first conductor, and a branched conductor in the metal tank connecting the vacuum valve and the first conductor.

### CROSS-REFERENCE TO RELATED APPLICATIONS

This application is based upon and claims the benefit of priority from the prior Japanese Patent Application No. 2001-83657 filed on Mar. 22, 2001, the entire contents of which are incorporated herein by reference.

### BACKGROUND OF THE INVENTION

1. Field of the Invention

This invention relates to a tank type vacuum circuit breaker applied to, for example, a transformer substation.

2. Description of the Related Art

The life of a contact of a dead tank type vacuum circuit breaker is long because a vacuum valve is used as an insulation portion of the vacuum circuit breaker. The tank-type vacuum circuit breaker is used even in a high-voltage substation of 84 kV class. Moreover, in a substation in urban suburbs, miniaturization and safety improvement of the system is needed due to a rise in land prices, etc. The tank-type vacuum circuit breaker attaches to a window-type current transformer which has suitable characteristics. In addition, in order to attain miniaturization, SF₆ gas, which has high insulation level and is excellent in the interrupting performance as an insulator filled up in a tank, is generally and widely used. FIG. 17 is a basic sectional view of such a dead tank type vacuum circuit breaker as a conventional example. A vacuum valve 1 of each phase is arranged inside the tank 2 of each phase. The tank 2 of each phase is oblong, two branched portions 2a, 2b branch away from each other in the upper part of the tank 2. Window-type current transformers 3a and 3b are attached to the branched portions 2a and 2b, respectively, and porcelain bushings 4a and 4b are arranged on the upper part of the transformers 3a, 3b, respectively.

Conductors 5a and 5b are formed in the porcelain bushings 4a and 4b, respectively, and the lower ends of these conductors 5a and 5b are connected to branched parts 1a and 1b arranged to the both ends of the vacuum valve 1, respectively.

An insulating support 7 is installed in one end side of the vacuum valve 1, and a operation rod 8 is arranged to penetrate the insulating support 7 and is operated to open or close by an operating mechanism 6.

In addition, SF₆ gas is fills the tank 2 as an insulator. In the conventional tank-type vacuum circuit breaker, SF₆ gas is used as an insulator. Since it is difficult to confine the SF₆ gas completely, it is generally permitted to leak 1% of the gas each year. However, since SF₆ gas is a global warming gas, reducing the leakage as much as possible is called for in recent years from a standpoint of an environmental issue.

Although it is possible to change the insulator to dry air, nitrogen gas (N₂), the mixture of SF₆ and either dry air or N₂, etc., as a method of reducing SF₆ gas, the dielectric strength of these gases is lower than that of the SF₆ gas. Thus, if the SF₆ gas is changed to one of these gases with no additional changes, the component of the circuit breaker must be enlarged, and thus it cannot achieve the above-mentioned miniaturization. Moreover, it costs too much.

### SUMMARY OF THE INVENTION

Accordingly, an object of the present invention which copes with the above-mentioned conventional situation is to provide a vacuum circuit breaker which reduces enclosure space of the insulator by a device of arrangement of a vacuum valve, etc., and to use dry air, N₂, and the mixture of SF₆ gas and either N₂ or dry air as the insulator for achieving excellent function in the environmental measure together with the miniaturization of the composition.

Additional purposes and advantages of the invention will be apparent to persons skilled in this field from the following description, or may be learned by practice of the invention.

According to an aspect of the invention, there is provided a vacuum circuit breaker, including, a metal tank with a first branched portion and a second branched portion, a first bushing hermitically connected to the first branched portion, a vacuum valve in the first bushing, a second bushing hermitically connected to the second branched portion, insulation gas in an inner hermetically sealed space of the metal tank, the first bushing, and the second bushing, a first conductor inside of the second bushing, and a branched conductor having a branching point in the metal tank, being in the metal tank and the first bushing, with a first end connected to the vacuum valve and a second end connected to the first conductor.

### BRIEF DESCRIMINATION OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 is a sectional view showing a vacuum circuit breaker of a first embodiment of this invention;

FIG. 2 is a sectional view showing a vacuum circuit breaker of a second embodiment of this invention;

FIG. 3 is a sectional view showing a vacuum circuit breaker of a third embodiment of this invention;

FIG. 4 is a sectional view showing a vacuum circuit breaker of a fourth embodiment of this invention;

FIG. 5 is a sectional view showing a vacuum circuit breaker of a fifth embodiment of this invention;

FIG. 6 is a sectional view showing a vacuum circuit breaker of a sixth embodiment of this invention;

FIG. 7 is a sectional view showing a vacuum circuit breaker of a seventh embodiment of this invention;

FIG. 8 is a sectional view showing a vacuum circuit breaker of an eighth embodiment of this invention;

FIG. 9 is a sectional view showing a vacuum circuit breaker of a ninth embodiment of this invention;

FIG. 10 is a sectional view showing a vacuum circuit breaker of a tenth embodiment of this invention;

FIG. 11 is a sectional view showing a vacuum circuit breaker of an eleventh embodiment of this invention;

FIG. 12 is a sectional view showing a vacuum circuit breaker of a thirteenth embodiment of this invention;

FIG. 13 is a sectional view showing a vacuum circuit breaker of a fourteenth embodiment of this invention;

FIG. 14 is a sectional view showing a vacuum circuit breaker of a fifteenth embodiment of this invention;

FIG. 15A is a plan view showing a three-phases vacuum circuit breaker of a sixteenth embodiment of this invention;

FIG. 15B is a side view corresponding to FIG. 15A;

FIG. 15C is a partially sectional view showing one phase portion corresponding to FIG. 15A;

FIG. 16 is a side view showing a vacuum circuit breaker of a seventeenth embodiment of this invention; and

FIG. 17 is a sectional view showing a conventional vacuum circuit breaker.

### DETAILED DESCRIPTION OF THE INVENTION

Referring now to the drawings, wherein like reference numerals designate identical or corresponding parts throughout the several views, embodiments of a vacuum circuit breaker of this invention will be described below.

First Embodiment

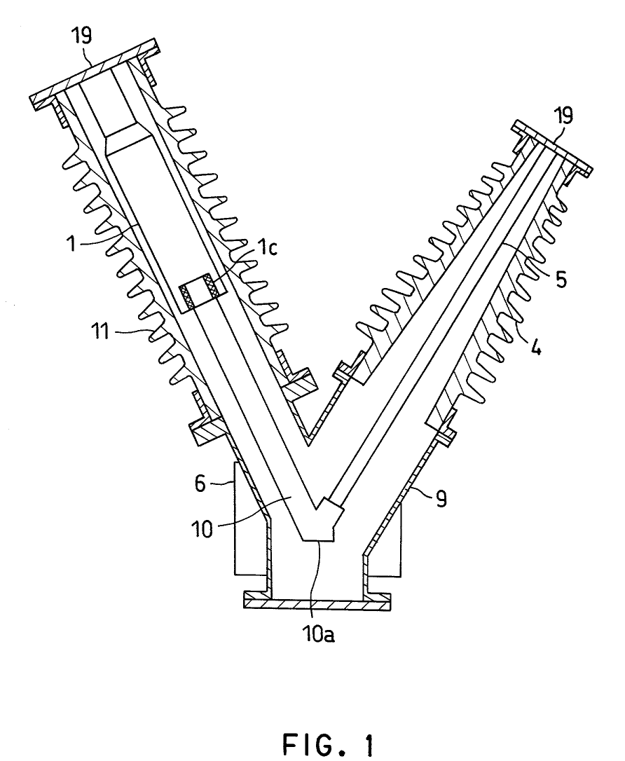

FIG. 1 is a sectional view showing a vacuum circuit breaker of a first embodiment of this invention. A tank-type vacuum circuit breaker of this embodiment includes a branched metal tank 9 which branches off in the cross-sectional view similar to a letter V. Bushings 4 and 11, which are porcelain bushings, for example, are directly connected to the ends of branched portions of the tank 9, respectively. Flanges 19 block the tip sides of the bushings 4, 11, and insulation gas is in the enclosed space. In such composition, one bushing 11 has a smaller diameter than the other bushing 4, and a vacuum valve is arranged in the smaller bushing 11.

A conductor 10 is connected to a vacuum valve 1 and arranged along the axial center of the bushing 11. The vacuum valve 1 is in the bushing 11. The conductor 10 has a branched portion 10a which branches in the tank 9 in the shape of a letter V at the lower end of the conductor 10. Hereafter, the conductor 10 is called a branched conductor 10. A straight conductor 5 is connected to the branched portion 10a of the branched conductor 10 and arranged in the bushing 4 which does not contain the vacuum valve 1.

Bellows 1c, for example a vacuum valve bellows, is arranged in the tank 9 side end of the vacuum valve 1, and the vacuum valve 1 is driven by an operating mechanism 6 arranged to the tank 9 via a drive rod (not illustrated) and the bellows 1c.

In the vacuum circuit breaker of this embodiment constructed as mentioned above, by installing the vacuum valve with a large diameter in a nonmagnetic material, that is, nonmetallic bushing 11 as an insulator, it becomes unnecessary to prepare a large gap between this bushing 11 and the vacuum valve 1.

Because the branched conductor 10 and the conductor 5 are installed in the tank 9, because the diameters of the conductors 10 and 5 are relatively small, and because the surfaces of the conductors 10 and 5 are smooth, as compared with the vacuum valve 1, the tank 9 is miniaturized, even if the required gap is set up.

Therefore, even if dry air, N₂, or the mixture of SF₆ and either dry air or N₂, etc., is used as an insulator, the circuit breaker is as small as the conventional one.

Thus, according to this embodiment, by installing the vacuum valve 1 which is an interception portion with large diameter and length in the bushing 11, an installation tank can be miniaturized and the electric field of the interception portion can be reduced.

Second Embodiment

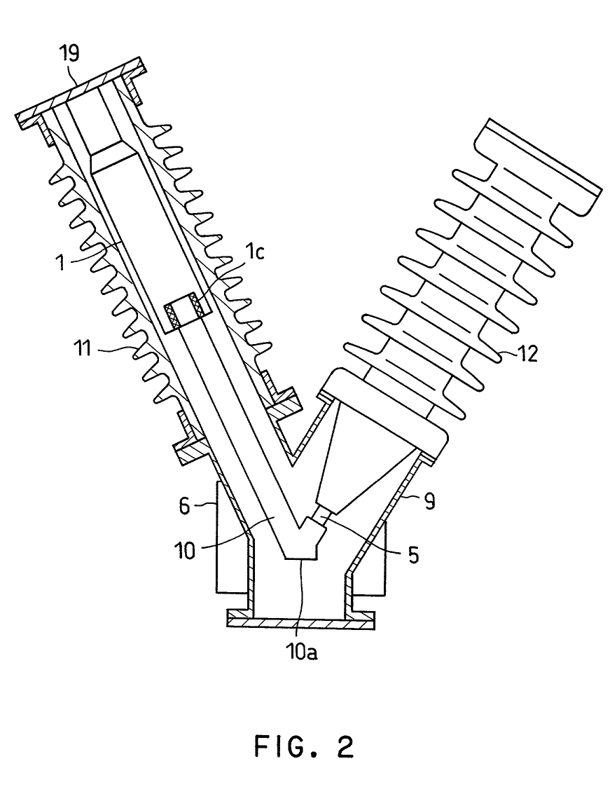

FIG. 2 is a sectional view showing a vacuum circuit breaker of a second embodiment of this invention. Although a vacuum circuit breaker of the second embodiment is similar to the first embodiment, a bushing, which does not contain the vacuum valve 1, is different.

As shown in FIG. 2, in the second embodiment, a bushing 12, which does not contain the vacuum valve 1, and a straight conductor 5 connected to the bushing 12 are molded bushing structures.

Since the other composition in FIG. 2 is similar to the first embodiment, the same portion in FIG. 2 is added as the same reference numeral of that in FIG. 1 and explanation about the same portion is omitted.

According to the second embodiment, in addition to the effect of the first embodiment, by introducing a molded bushing to the bushing 12, which does not contain the vacuum valve 1 and the conductor 5, the necessary space to contain insulation can be made small, and the amount the insulation gas used can be reduced.

Therefore, in addition to the same effect as the first embodiment, if SF₆ gas or the mixture of SF₆ and others is used as the insulation gas, it is advantageous that not only the usage amount of SF₆ gas but the equipment cost can be reduced.

Third Embodiment

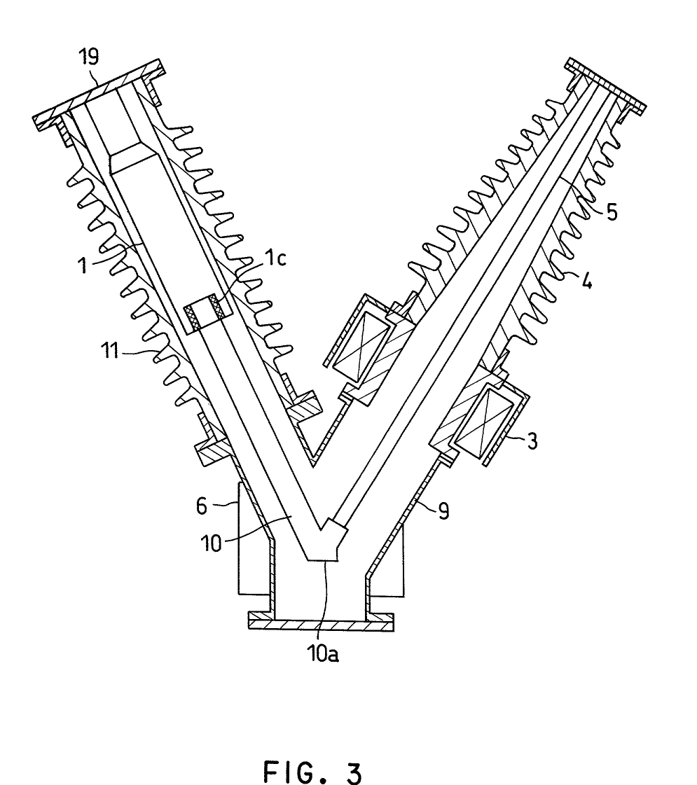

FIG. 3 is a sectional view showing a vacuum circuit breaker of a third embodiment of this invention. Since a vacuum circuit breaker of this embodiment is similar to the first embodiment, in which the vacuum valve 1 is installed in the bushing 11, explanation about a component of this embodiment which is the same as that of the first embodiment is omitted with adding in FIG. 3 the same reference numeral as shown in FIG. 1.

In the third embodiment, as shown in FIG. 3, a window-type current transformer 3 is arranged on the periphery of the connection part of the tank 9 and the bushing 4 which does not contain the vacuum valve 1.

According to the third embodiment, since the diameter of the bushing 4 which does not contain the vacuum valve 1 can be made small, by arranging the window-type current transformer 3 on the bushing 4 side, the window-type current transformer 3 is miniaturized. In addition to the effect of the first embodiment, the advantage of miniaturization of the composition of the tank-type vacuum circuit breaker can be acquired.

Fourth Embodiment

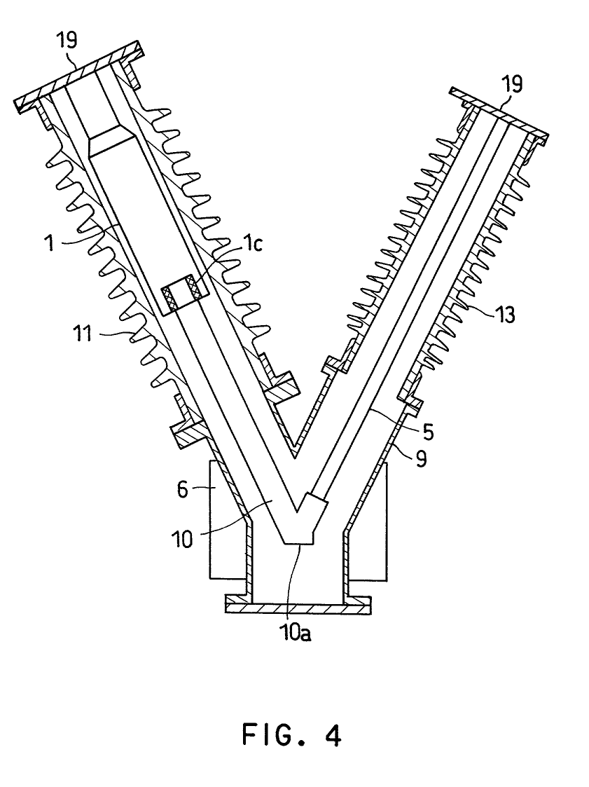

FIG. 4 is a sectional view showing a vacuum circuit breaker of a fourth embodiment of this invention. Since a vacuum circuit breaker of this embodiment is similar to the first embodiment, in which the vacuum valve 1 is installed in the bushing 11, a component of this embodiment shown in FIG. 4 which is the same as that of the first embodiment shown in FIG. 1 is explained while referring to the same reference numeral.

In the fourth embodiment, as shown in FIG. 4, one bushing of the side which does not contain the vacuum valve 1 is a compound bushing 13 which consists of composite material containing a pressure-resistant material, etc. In addition, the compound bushing 13 is also applicable to the bushing 11 of the side which contains the vacuum valve 1.

According to the fourth embodiment, since the bushing is the compound bushing 13, the vacuum circuit breaker which contains high-pressure insulation gas inside is more explosion-proof. As compared with the case consisting only of porcelain bushings, the structure is simple, and the quantity and the cost are reduced. The structure enables transporting the breaker filled up with gas.

Fifth Embodiment

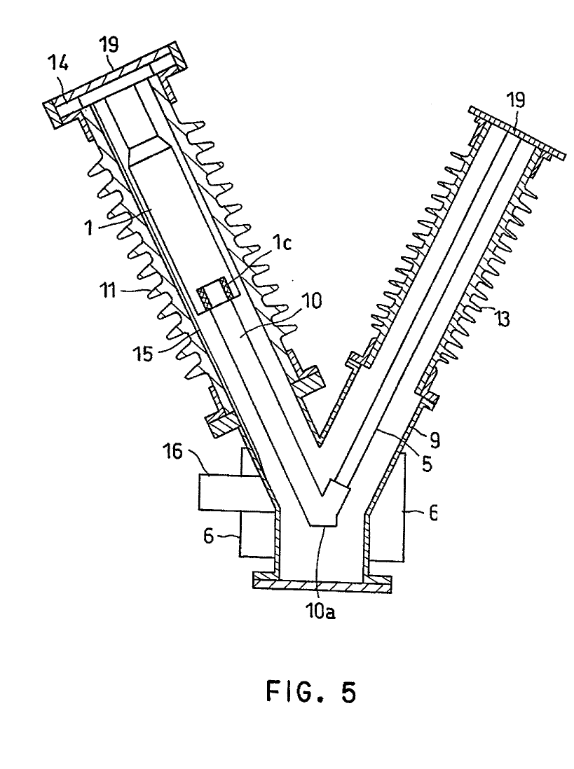

FIG. 5 is a sectional view showing a vacuum circuit breaker of a fifth embodiment of this invention. As shown in FIG. 5, in a vacuum circuit breaker of this embodiment, a current transformer 14 of Rogowski type, which is known as non-iron core type current transformer, is at the tip of the opposite side to the side connected to the tank 9 of the bushing 11 and between conductors of an outer main circuit (not illustrated). An optical cable in the bushing 11 connects the Rogowski type current transformer 14 is connected to a control device (not illustrated) in a grounded control box 16. An amplifier (not illustrated) for amplifying current transformed from an optical signal is in the control device.

In addition, the circuit breaker of the fifth embodiment is, for example, constituted on the basis of the circuit breaker shown in the fourth embodiment mentioned above, thus the explanation of the same portion as shown in FIG. 4 is omitted with the same reference numeral. However, of course, it is also possible to constitute on the basis of the circuit breaker shown in either FIGS. 1, 2, or 3.

In the fifth embodiment, by arranging the Rogowski type current transformer 14 at the tip opposite to the side connected to the tank 9 of the bushing 11 containing the vacuum valve 1, and connecting this Rogowski type current transformer 14 and the control device in the control box 16 installed on ground by the optical cable 15 installed in the bushing 11, even when the vacuum valve 1 is formed in the bushing 11, it becomes possible to arrange the current transformer on both sides of the vacuum valve 1.

Moreover, by outputting by the optical cable 15 installed in the bushing 11 and installing the amplifier for amplifying current transformed from optical signals as a control device, it can use a protective relay which was already established, and it makes an effect that the circuit breaker can be installed without changing a load of relay in the control side.

Sixth Embodiment

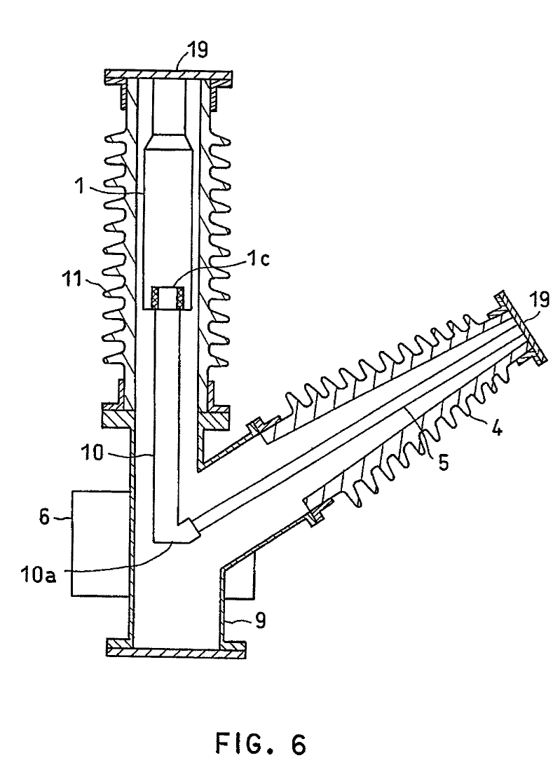

FIG. 6 is a sectional view showing a vacuum circuit breaker of a sixth embodiment of this invention. Although a vacuum circuit breaker of this embodiment is similar to the first embodiment, the axial center of the bushing 11 and the axial center of the tank 9 differ.

As shown in FIG. 6, the bushing 11, containing the vacuum valve 1, is perpendicular to the ground on which the tank 9 rests. One branched portion of the tank 9 is also perpendicular to the ground under the branching point of the branched conductor.

Since the other components are the same as those of the first embodiment, the explanation of the other components is omitted with adding in the FIG. 6 the same reference numerals as shown in FIG. 1.

According to the sixth embodiment, by aligning the axial center of the bushing 11 containing the vacuum valve and the axial center of the tank 9, it becomes easier to connect the branch conductor 10 in the tank 9 and the vacuum valve 1, and moreover it has an effect to reduce size and cost.

Seventh Embodiment

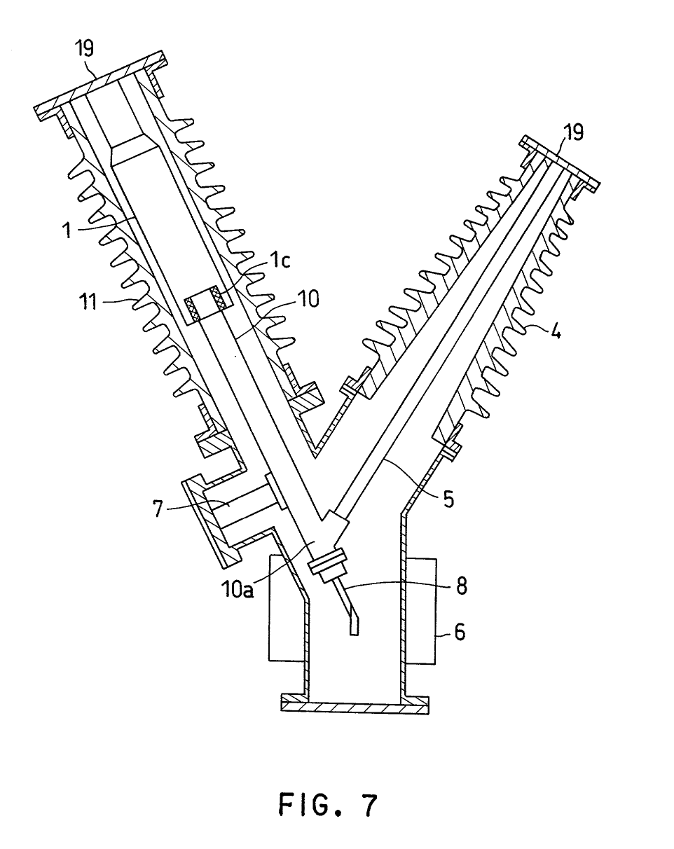

FIG. 7 is a sectional view showing a vacuum circuit breaker of a seventh embodiment of this invention. Since a vacuum circuit breaker of this embodiment is similar to the first embodiment, in which the vacuum valve 1 is installed in the bushing 11, explanation about a component of this embodiment which is the same as that of the first embodiment is omitted with adding in FIG. 7 the same reference numeral as shown in FIG. 1.

In the seventh embodiment, as shown in FIG. 7, an insulating support 7 projected from an inner surface of the tank 9 supports the side of the branched conductor 10, and thus the branched conductor is fixed in the tank 9. The inside of the branched conductor 10 is hollow, and an operation rod 8 drives the vacuum valve 1 through the hollow space. The operation rod 8 is connected to the operating mechanism 6.

According to the seventh embodiment, by fixing the side of the branched conductor 10 and the inner surface of the tank 9 by installing the insulating support 7, and penetrating the operation rod 8 for driving the vacuum valve 1 in the hollow space inside the branched conductor 10, it makes easier to support the conductor of the vacuum circuit breaker and thus it can be miniaturized.

Eighth Embodiment

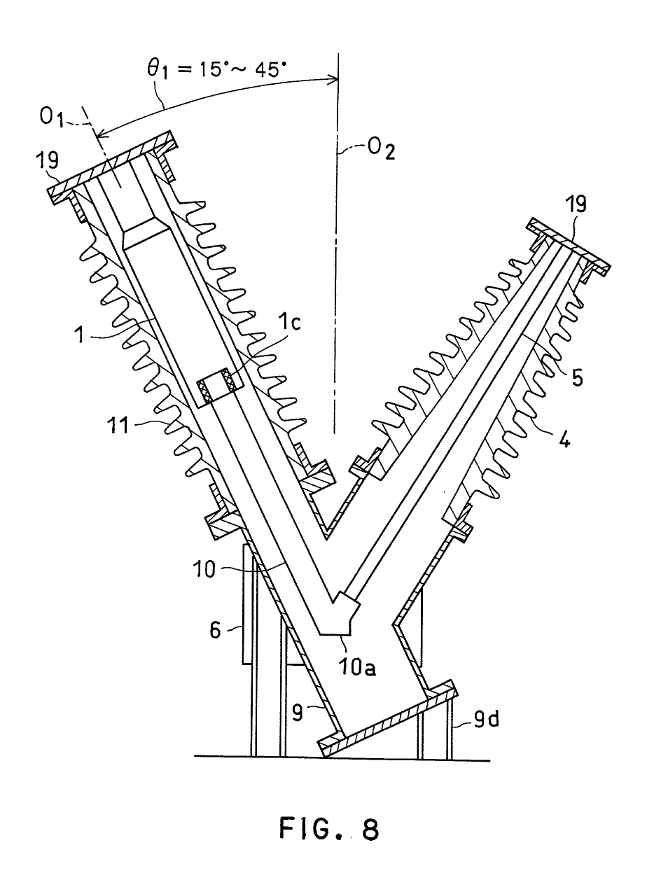

FIG. 8 is a sectional view showing a vacuum circuit breaker of an eighth embodiment of this invention. As shown in this FIG. 8, in a vacuum circuit breaker of the eighth embodiment, an axial center direction O1 of the tank 9 is offset between 15 and 45 degrees from an axial center direction O2 perpendicular to the plane or ground on which the tank 9 is installed, typically the vertical axis.

In addition, FIG. 8 shows an example of leaning the axial direction in the composition shown in FIG. 6 at the above-mentioned angle. In this case, the tank 9 is supported by a support frame 9d at the groundside. Since the other composition in FIG. 8 is similar to the sixth embodiment, the same portion in FIG. 8 is added as the same reference numeral of that in FIG. 6 and explanation about the same portion is omitted.

According to the eighth embodiment, by inclining the axial center O1 of the tank 9 at an angle between 15 and 45 degrees, the height of the tip of the bushings 11 approaches the height of the bushing 4. The connection work of the bushings becomes easier because the heights of the bushings as a conductor pulling out from outside is nearly equal, and since a charging portion becomes higher and in a gathered state, it can be miniaturized.

Ninth Embodiment

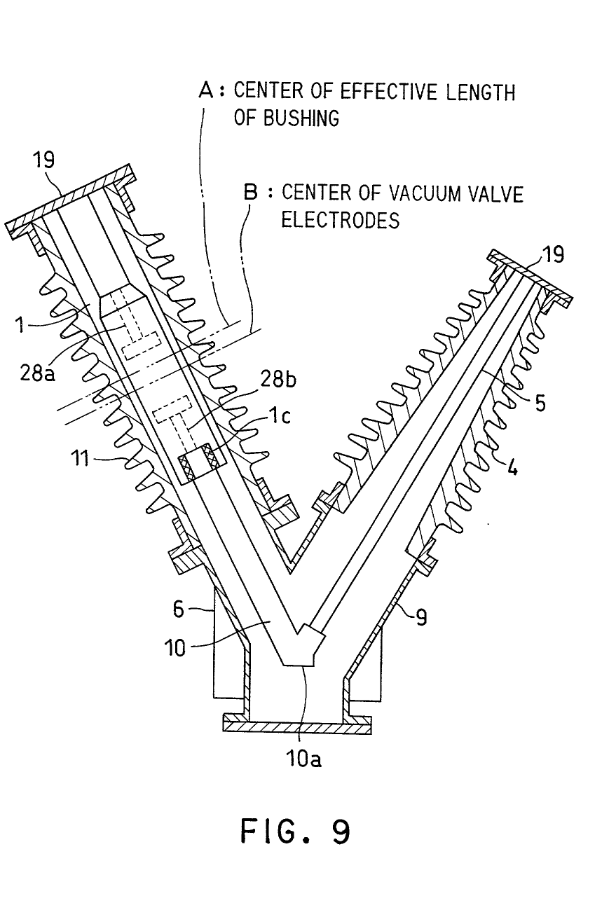

FIG. 9 is a sectional view showing a vacuum circuit breaker of a ninth embodiment of this invention. A vacuum circuit breaker of the ninth embodiment is similar to the first embodiment. However, as shown in FIG. 9, in the ninth embodiment, a electrodes center B between two contacts 28a, 28b of the vacuum valve is positioned nearer to the tank 9 than the center A of the effective length of the bushing 11.

Since the other components are the same as those of the first embodiment, the explanation of the other components is omitted with adding in the FIG. 9 the same reference numerals as shown in FIG. 1.

According to the ninth embodiment, by positioning the electrodes center B of the vacuum valve 1 nearer to the tank 9, an influence from a charging portion can be suppressed when the bushing 11 is in a high-voltage side in an insulated state. Therefore the bushing 11 is shortened and miniaturized as a whole.

Tenth Embodiment

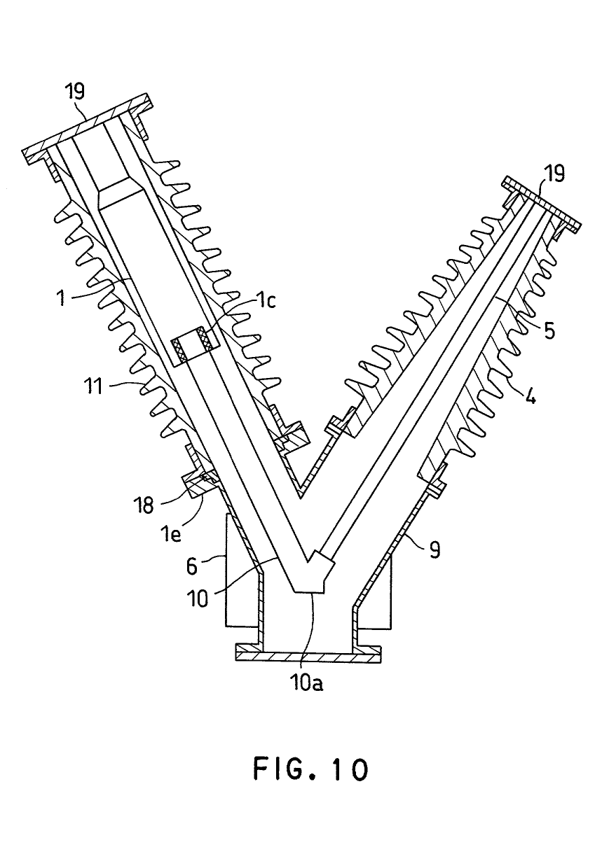

FIG. 10 is a sectional view showing a vacuum circuit breaker of a tenth embodiment of this invention. A vacuum circuit breaker of this embodiment is similar to the first embodiment. However, as shown in FIG. 10, in the tenth embodiment, an insulation ring 18, which has a gas sealing portion, is on a connection portion between the bushing 11, which contains the vacuum valve 1, and the tank 9. The bushing 11 side of a flange le is on the tip of the branched portion of the tank 9.

Since the other composition in FIG. 10 is similar to the first embodiment, the same portion in FIG. 10 is added as the same reference numeral of that in FIG. 1 and explanation about the same portion is omitted.

According to the tenth embodiment, since the gas seal portion is made not of metal but of an insulator by arranging the insulation ring 18 on the flange le of the branched portion of the tank 9 which is connected to the bushing 11, it is possible to minimize the diameter of the flange, for example, by improvement of the sealing. The miniaturization of composition is thus attained.

Eleventh Embodiment

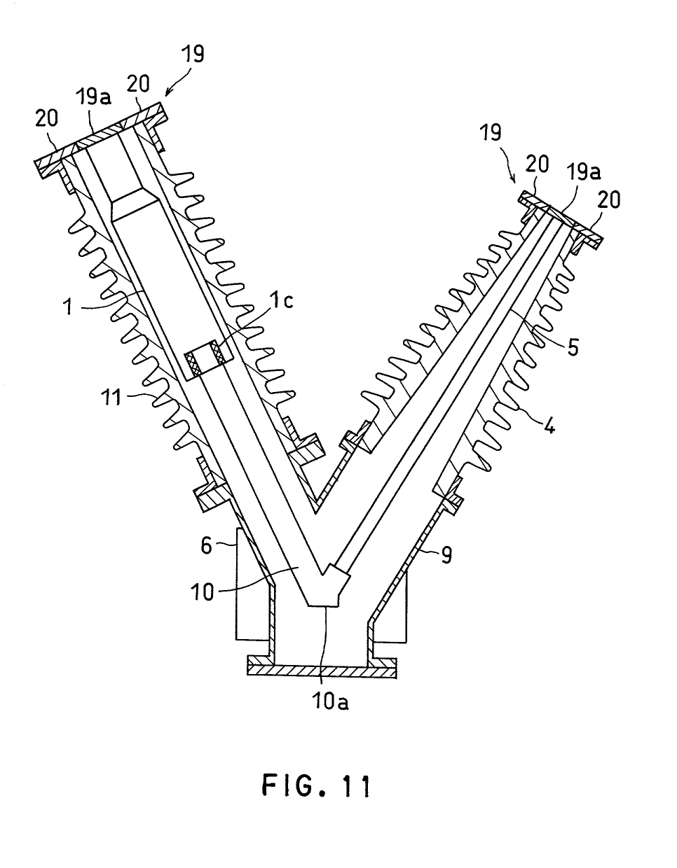

FIG. 11 is a sectional view showing a vacuum circuit breaker of an eleventh embodiment of this invention. A vacuum circuit breaker of the eleventh embodiment is similar to the first embodiment. A flange 19 is installed on the tip of the bushing 11 containing the vacuum valve 1. As shown in FIG. 11, in the eleventh embodiment, the flange (power-circuit flange) 19 for connecting with an external power circuit is formed as an integrated component at the tip of the bushing 11 which contains the vacuum valve 1. The flange 19 includes a center portion 19a as a connection portion made from copper, and a periphery portion 20 connected to the bushing 11 made of aluminum.

In addition, since the other components are the same as those of the first embodiment, the explanation of the other components is omitted with adding in the FIG. 11 the same reference numerals as shown in FIG. 1.

According to the circuit breaker of the eleventh embodiment, by arranging the flange as a united component composed of the center part 19a made of copper and the periphery portion 20 made of aluminum, a large current can be conducted by the central portion 19a as a conductor. It can reduce weight by arranging the periphery portion 20 made of light aluminum. The conductivity is thus improved while reducing weight, and the miniaturization can be achieved.

Twelfth Embodiment

A vacuum valve circuit breaker of a twelfth embodiment of this invention concerns the pressure of the insulation gas. The structure of the twelfth embodiment is similar to that of the first embodiment.

In the twelfth embodiment, a nonmagnetic material whose pull intensity is not less than 60 kg/mm², such as Inconel, is applied to material of the bellows 1c of the vacuum valve 1.

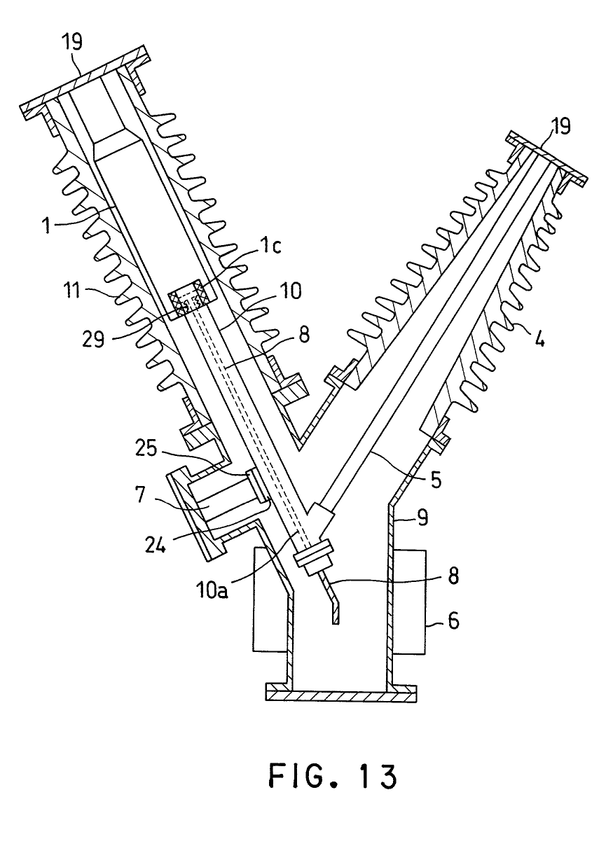

On this condition, the pressure of the insulation gas is set up so that a generated load by the pressure difference brought on the bellows 1c of the vacuum valve 1 is not less than one third, for example, half, of a wipe spring load which is necessary at a contact of the vacuum valve 1, which is shown as reference numerals 28a, 28b in FIG. 9, and the generated load is not more than a necessary load. For an instance, as shown in FIG. 13, a wipe spring 29 is arranged between the control rod 8 and the bellows 1c of the vacuum valve 1. Thus, the generated load by the pressure difference brought on the bellows 1c of the vacuum valve 1 is used as a supplement of strength of the wipe spring.

According to this embodiment of such composition, by using the nonmetallic substance with the pull intensity of no less than 60 kg/mm² as a material of the bellows 1c of the vacuum valve 1, the intensity of the bellows 1 c of the vacuum valve 1 is increased and thus the pressure difference brought on the bellows 1c can be enlarged, therefore, the pressure of the inside insulation gas can be raised and the miniaturization of the composition can be achieved.

Moreover, by setting the insulated gas pressure so that the generated load by the pressure difference brought on the bellows 1c of the vacuum valve 1 is not less than one third of the wipe spring load which is necessary for the contact of the vacuum valve 1 and not more than the necessary load, the generated load by the pressure difference brought on the bellows 1c of the vacuum valve 1 is used as a supplement of the strength of the wipe spring, and thus the composition of the wipe spring can be simplified, therefore the miniaturization can be achieved.

Thirteenth Embodiment

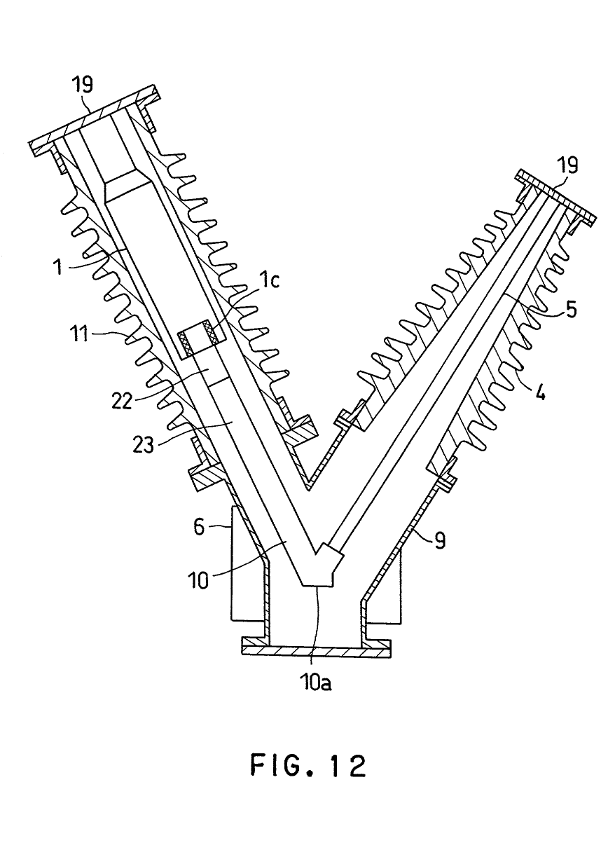

FIG. 12 is a sectional view showing a vacuum circuit breaker of a thirteenth embodiment of this invention. A vacuum circuit breaker of the thirteenth embodiment improves a conductor. Since the other components are the same as those of the first embodiment shown in FIG. 1, the explanation of the other components is omitted.

As shown in FIG. 12, the vacuum valve 1 side connection portion 22 of the branched conductor 10 connected to the vacuum valve 1 is made of copper, and the other portion 23 of the branched conductor 10 is made of aluminum.

According to such composition, by arranging the vacuum valve 1 side connection portion 22 of the branched conductor 10 made of copper and the other portion 23 made of aluminum, the branched conductor 10 has a high conductivity and light weight. Therefore, according to this embodiment, it can be lightweight, and the conductivity performance can be made adequate, thus the miniaturization can be promoted.

Fourteenth Embodiment

FIG. 13 is a sectional view showing a vacuum circuit breaker of a fourteenth embodiment of this invention. A vacuum circuit breaker of this embodiment includes composed of a metal tank 9, and bushings 11 and 4 are connected to the tips of branched portions of the tank 9, respectively. Flanges 19 block the tips of the bushings 11 and 4. Insulated gas is in the enclosed space. A diameter of the bushing 11 is smaller than that of the bushing 4, and the bushing 11 with a smaller diameter contains the vacuum valve 1.

A branched conductor 10 is connected to the vacuum valve 1 along with an axial center of the bushing 11 containing the vacuum valve 1. A straight conductor 5, arranged in the bushing 4 which does not contain the vacuum valve 1, is connected to the branched portion 10a of the branched conductor 10. The vacuum valve 1 has vacuum valve bellows 1c at the end side of the tank 9.

In this embodiment, an insulating support 7 is fixed and projects into the tank 9 from the inside surface of the tank 9, and the branched conductor 10 is supported at the tip of the insulating support 7 through a seat 24. An insulation film 25 is formed on the periphery of the insulating support 7 side surface of the seat 24, etc. The film 25 is made from, for example, polytetrafluoroethylene or fluororesin.

According to this embodiment, by forming the insulation film 25 close to the seat 24 on the branched conductor 10 supported by the insulating support 7 in the tank 9, the insulation effect of a support portion of the branched conductor 10 to the tank 9 is raised, and thus even if gas whose insulation effect is less than that of SF₆ gas is used as the insulation gas, the miniaturization can be performed.

Fifteenth Embodiment

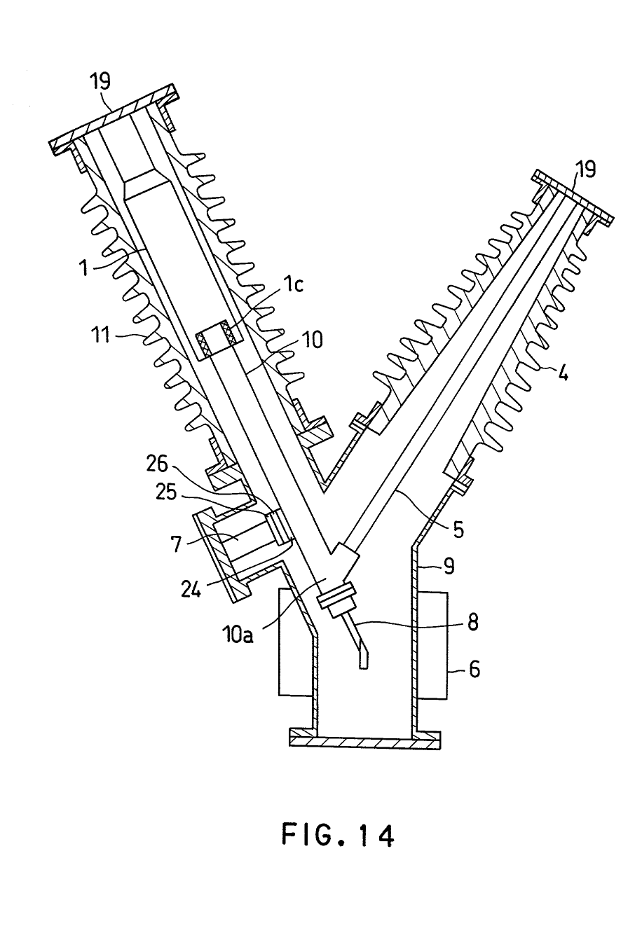

FIG. 14 is a sectional view showing a vacuum circuit breaker of a fifteenth embodiment of this invention. This embodiment modifies the fourteenth embodiment. In this embodiment, as shown in FIG. 14, the insulation film 25 is formed at the periphery of the surface of the seal 24 of the branched conductor 10, etc., through an aluminum-sprayed component 26. The other structure is the same as that of the fourteenth embodiment.

According to this embodiment, by forming the insulation film 25 made from, for example, polytetrafluoroethylene or a fluororesin, close to the surface of the branched conductor, such as the surface of the seat 24, through the aluminum-sprayed component 26, which has a microscopically porous structure, the insulation film 25 can be stuck well and more reliable film formation can be performed.

Therefore, by spraying aluminum between the insulator film 25 and the surface of the conductor, the effect of improvement of the adhesion of the insulation film and reliability can be achieved.

Sixteenth Embodiment

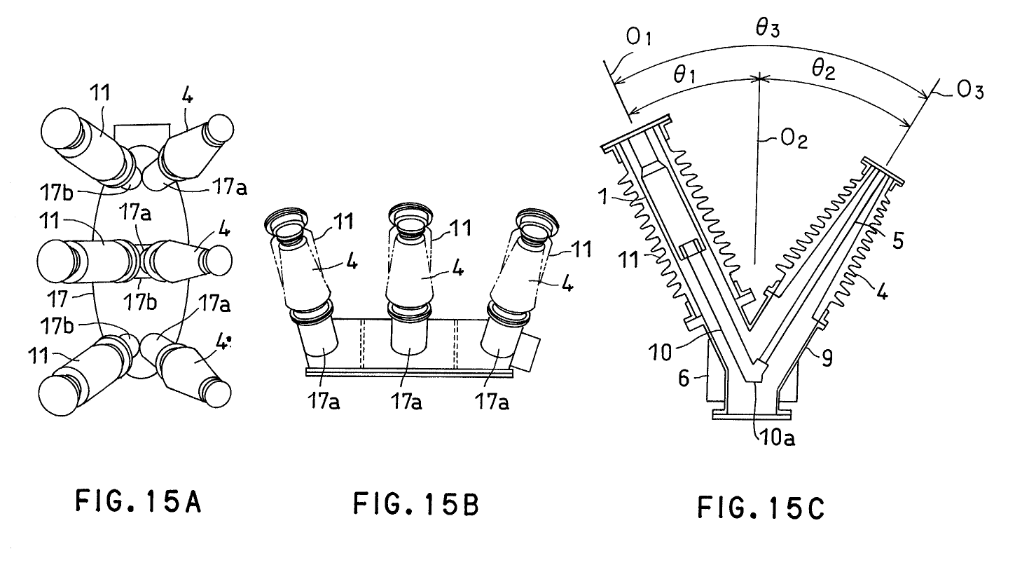

A Sixteenth embodiment of this invention is a three-phase structure using any vacuum circuit breaker of this invention, including embodiments one through fifteen. s in previous embodiments. FIG. 15A is a plan view showing a three-phase vacuum circuit breaker; FIG. 15B is a side view showing the three-phase vacuum circuit breakers; and FIG. 15C is a sectional view showing one phase component of the three-phase vacuum circuit breaker.

As shown in the figures, in the vacuum circuit breaker in this embodiment, three phases of conductors 10 and 5 are installed in one tank 17. The_tank 17 is elliptic in the plan view and half-cylindrical in the sectional view, and the upper surface of the tank 17 curves below gradually along with the direction from the center toward the minor-axis side. Three phases of branched portions 17a, 17b face each other and are arranged at the facing position in the minor-axis side to the center of the upper surface of the tank 17. In each pair of branched portions 17a, 17b, three phases of bushings 11, 4 stand and attach in the form of a letter V.

As shown in FIG. 15C, in each phase, the bushing 11, of which an axial center direction is O1, leans not less than 13 degrees (designated as θ1) to a perpendicular axis O2 of the plane or ground on which the tank 9 is installed, typically the vertical axis. The bushing 4, of which an axial center direction is O3, leans not less than 13 degrees (designated as θ2) to the axis O2. The bushing 11 leans not less than 30 degrees (designated as θ3) to the bushing 4.

In addition, the detailed composition for each phase is the same as that of, for example, the one shown in FIG. 1.

In the sixteenth embodiment, since a grounding side of one tank 17 is arranged in elliptic fan-shaped, and three first branched portions are arranged to connect the bushings at the upper part or the side of the tank 17, respectively, and three second branched portions are arranged to lean to the first branched portions, respectively. Each first branched portion leans not less than 30 degrees to the corresponding second branched portion, respectively, and all of the first branched portions and the second branched portions lean not less than 13 degrees to the perpendicular axis to the installation plane or ground respectively. Thus in this embodiment, three phase conductor assemblies are arranged in one tank; the whole composition of the tank-type vacuum circuit breaker can be miniaturized; and the necessary amount of filled insulation gas can be sharply reduced.

Seventeenth Embodiment

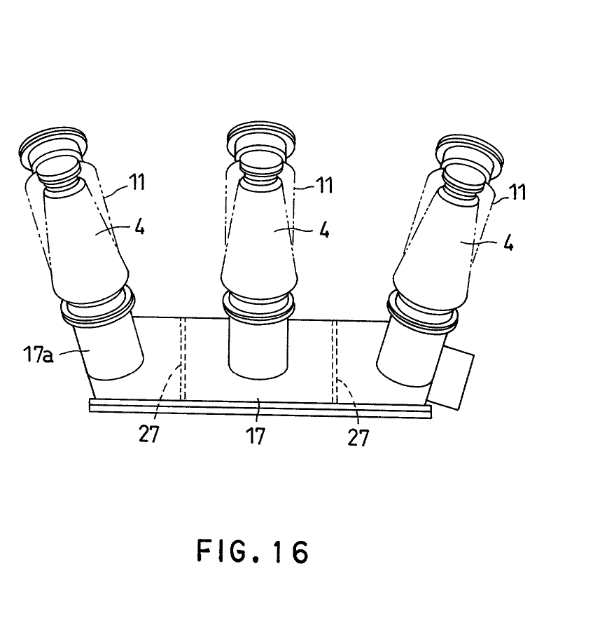

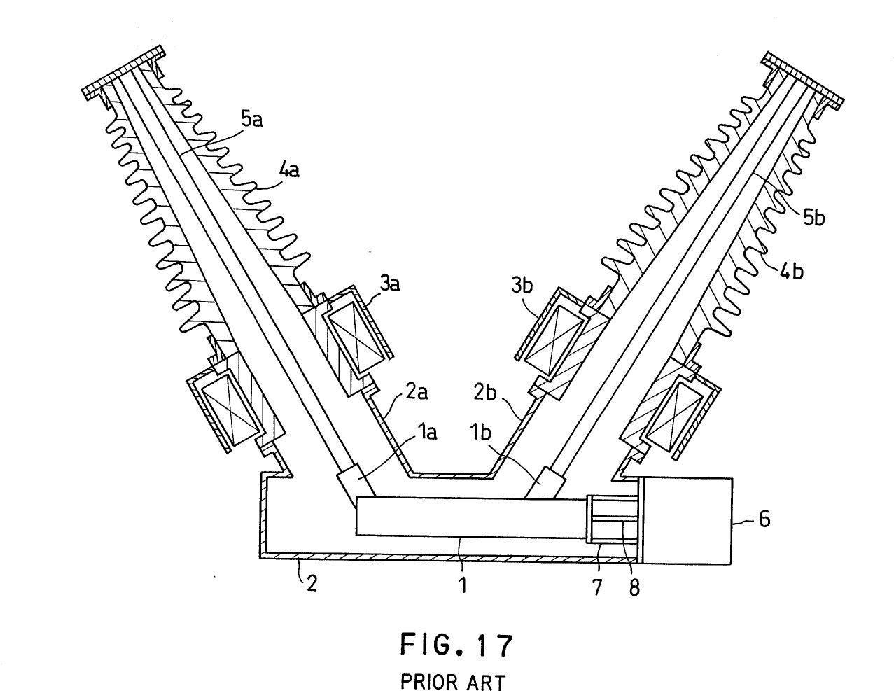

FIG. 16 is a side view showing tank-type vacuum circuit breaker of a seventeenth embodiment of this invention. The seventeenth embodiment modifies the sixteenth embodiment. In this embodiment, as shown in FIG. 16, insulation plates 27 are arranged in each portion between different phases of the tank portion 17 used as a ground of the tank 17 containing three phases of the conductors, respectively.

According to this embodiment, by arranging the insulation plate 27 between three phases of the charge portions in the tank 17, respectively, the distance between phases can be shortened. Therefore, the composition can be miniaturized from this point, and the necessary amount of filled insulation gas can be reduced.

Eighteenth Embodiment

An eighteenth embodiment of this invention concerns the insulation gas applicable to any of the previous embodiments. In this embodiment, the insulation gas is selected from the group consisting of dry air, nitrogen gas (N₂), a mixture of dry air and N₂, and a mixture of SF₆ gas in a concentration of within 50 wt % and at least one of dry air and nitrogen gas, which is applicable to any of the above-mentioned first through seventeenth embodiments. By selecting the insulation gas as such, the SF₆ gas as a global warming gas can be sharply reduced. Moreover, if the mixture of dry air and N₂ is used, N₂ is filled without making evacuated, thus the effect of low manufacture cost of the system can be acquired. In addition, the mixture of N₂ and very small amount of SF6 within 1% can be also used as the insulation gas.

In this case, if the N₂ gas is used independently as the insulator of the vacuum circuit breaker, one cannot find gas leaks in a conventional method. However, one can be easily find gas leaks by adding a slight amount of SF₆ gas which can be found by a halogen gas leak detector.

As explained above, according to the vacuum circuit breaker of this invention, by arranging the vacuum valve in the bushing and the conductor in the tank, space of the vacuum circuit breaker can be reduced and the whole composition can be miniaturized.

The vacuum circuit breaker can use dry air, N₂, a mixture of slight of SF₆ and either N₂ or dry air, etc., and therefore it can respond to the request of both global warming prevention and the miniaturization of the composition.

The foregoing discussion discloses and describes merely a number of exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting, of the scope of the invention, which is set forth in the following claims. Thus, the present invention may be embodied in various ways within the scope of the spirit of the invention.

What is claimed is:

1. A vacuum circuit breaker, comprising:
a metal tank with a first branched portion and a second branched portion;
a first bushing hermetically connected to the first branched portion;
a vacuum valve in the first bushing;
a second bushing hermitically connected to the second branched portion;
insulation gas in an inner hermetically sealed space of the metal tank, the first bushing, and the second bushing;
a first conductor inside of the second bushing; and
a branched conductor having a branching point in the metal tank, being in the metal tank and the first bushing, with a first end connected to the vacuum valve and a second end connected to the first conductor.

2. The vacuum valve breaker as recited in claim 1, wherein:
at least one of the first bushing and second bushing comprises a composite material.

3. The vacuum valve breaker as recited in claim 1, further comprising:
a current transformer of Rogowski type for detecting current flowing through the branched conductor arranged on an end portion opposite to a tank side of the first bushing;
a control device arranged outside the first bushing for outputting a control signal; and
an optical cable arranged through inside of the first bushing connected between the current transformer and the control device to transmit the control signal.

4. The vacuum circuit breaker as recited in claim 1, wherein:
the second bushing and the first conductor have a molded structure.

5. The vacuum circuit breaker as recited in claim 1, further comprising:
a window type current transformer for detecting current flowing through the first conductor arranged on a connection portion of the second bushing and the second branched portion of the metal tank.

6. The vacuum circuit breaker as recited in claim 1, wherein:
an axial direction of the first bushing is aligned with an axial direction of a lower part of the metal tank under the branching point of the branched conductor.

7. The vacuum circuit breaker as recited in claim 1, wherein:
an angular difference between an axial direction of a lower part of the metal tank under the branching point and a line perpendicular to the metal tank installation plate between 15 and 45 degrees.

8. The vacuum circuit breaker as recited in claim 1, wherein:
the vacuum valve is arranged such that a center point between electrodes of the vacuum valve is nearer to the tank than a center point of an effective length of the first bushing.

9. The vacuum circuit breaker as recited in claim 1, further comprising:
a flange connected to an end portion opposite to a tank side of at least one of the first bushing and the second bushing having, a center part of which is made of copper and a periphery part of which surrounding the center part is made of aluminum.

10. The vacuum circuit breaker as recited in claim 1, wherein:
the vacuum valve includes a bellows portion, a pressure of the insulation gas enclosed in the metal tank is set such that a load generated by pressure difference applied to the bellows portion is not less than one third of a wipe spring load necessary for contacts of the vacuum valve and not more than the wipe spring load necessary for contacts of the vacuum valve.

11. The vacuum circuit breaker as recited in claim 1, wherein:
the vacuum circuit includes a bellows portion composed of a nonmagnetic material whose intensity in the tank is not less than 60 kg/mm².

12. The vacuum circuit breaker as recited in claim 1, wherein:
the branched conductor is composed of a first portion Made of copper connected to the vacuum valve and a second portion made of aluminum connected to the first conductor.

13. The vacuum circuit breaker as recited in claim 1, further comprising:
an insulating support portion projected from an inner surface of the metal tank for supporting and fixing the branched conductor.

14. The vacuum circuit breaker as recited in claim 13, further comprising an operation rod for driving the vacuum valve, wherein:
the branched conductor is hollow, and the operation rod projects through the branched conductor.

15. The vacuum circuit breaker as recited in claim 13, wherein:
the insulating support portion is provided with a seat at a position on the insulating support portion supports the branched conductor, and a surface of the seat on the insulating support portion is covered by an insulation film.

16. The vacuum circuit breaker as recited in claim 15, wherein:
the insulating support portion is provided with an aluminum-sprayed material provided between the seat and the insulation film.

17. The vacuum circuit breaker as recited in claim 1, wherein:
the insulation gas is selected from the group consisting of dry air, nitrogen gas, a mixture of dry air and nitrogen, and a mixture of SF₆ gas in a concentration of within 50 wt % and at least one of dry air and nitrogen gas.

18. The vacuum circuit breaker as recited in claim 17, wherein:
the metal tank contains three conductor assemblies, each of which is composed of the first bushing, the second bushing, the vacuum valve contained in the first bushing, the first conductor contained in the second bushing, and the branched conductor connecting the vacuum valve and the first bushing.

19. A vacuum circuit breaker, comprising:
a metal tank with three sets each comprising a first branched portion and a second branched portion;
three first bushings, each hermitically connected to one of the first branched portions;
three second bushings, each hermitically connected to one of the second branched portions;
insulation gas in inner hermetically sealed spaces of the metal tank, the three first bushings, and the three second bushings;
three vacuum valves each in one of the first bushings;
three first conductors, each inside of one of the second bushings; and
three branched conductors, each having a branching point in the metal tank, being in the metal tank and one of the first bushings, and each provided with a first end connected to one of the vacuum valves and a second end connected to one of the first conductors.

20. The vacuum circuit breaker as recited in claim 18, wherein:
each of axial directions of the first bushings is arranged at not less than 30 degrees separated from one of axial directions of the second bushings, respectively; and
each of axial directions of the first bushings and the second bushings is arranged at not less than 13 degrees separated from a direction of a perpendicular axis to a ground on which the metal tank is installed, respectively.

21. The vacuum circuit breaker as recited in claim 18, further comprising:
an insulation plate installed between the conductor assemblies for separating charging portions of three-phases conductor assemblies each other.
